(19) United States
(12) Patent Application Publication
(10) Pub. No.: US 2008/0002945 A1
(43) Pub. Date: Jan. 3, 2008

(54) Reproduction control apparatus, reproduction control method, and reproduction apparatus

(75) Inventors: Chikara Ushimaru, Hamura-shi (JP); Takehiko Okuyama, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/806,387

(22) Filed: May 31, 2007

(30) Foreign Application Priority Data
May 31, 2006 (JP) 2006-152706

(51) Int. Cl. H04N 7/00

(52) U.S. Cl. 386/95

(57) ABSTRACT

According to one embodiment, a reproduction control method includes instructing a first reproduction apparatus connected to a recording apparatus for recording a content to reproduce the content, instructing the first reproduction apparatus to stop reproduction of the content, receiving reproduction collateral information of the content obtained in accordance with reproduction and reproduction stop of the content by the first reproduction apparatus, and transmitting the reproduction collateral information to a second reproduction apparatus connected to the recording apparatus to instruct reproduction of the content on the basis of the reproduction collateral information.

### CROSS-REFERENCE TO RELATED APPLICATIONS

This application is based upon and claims the benefit of priority from Japanese Patent Application No. 2006-152706, filed May 31, 2006, the entire contents of which are incorporated herein by reference.

### BACKGROUND

1. Field

One embodiment of the invention relates to a reproduction control method and reproduction control apparatus for controlling a content reproduction apparatus connectable to a content recording apparatus via a network. Another embodiment of the invention relates to a content reproduction apparatus connectable to a content recording apparatus via a network.

2. Description of the Related Art

Recently, research and development of DVDs (Digital Versatile Discs) have flourished. A DVD includes first, second, and third logic units, as defined by the DVD standard. The first logic unit is a DVD player application that relays a user command to the second logic unit. The second logic unit is a DVD navigator that reads data on a DVD on the basis of the user command. The third logic unit is a DVD presentation that decompresses the data read from the DVD.

For example, if a user wants to stop watching a movie (moving image) at a specific location on a DVD and resume watching from the specific location later, the user must remember the location and manually navigate to find the location. This is inconvenient.

Jpn. Pat. Appln. KOKAI Publication No. 2002-237173 discloses a technique of causing a DVD player application to bookmark a specific location and resume reproduction from the specific location on the basis of the bookmark.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a view showing the outline of a reproduction/recording system according to an embodiment of the invention;

FIG. 2 is a block diagram showing the schematic arrangement of a control apparatus according to the embodiment;

FIG. 3 is a block diagram showing the schematic arrangement of a reproduction apparatus according to the embodiment;

FIG. 4 is a view showing an example of reproduction control in the reproduction/recording system according to the embodiment;

FIG. 5 is a flowchart showing a reproduction start process according to the embodiment;

FIG. 6 is a flowchart showing a reproduction stop process according to the embodiment; and

FIG. 7 is a flowchart showing a reproduction resume process according to the embodiment.

### DETAILED DESCRIPTION

Various embodiments according to the invention will be described hereinafter with reference to the accompanying drawings. In general, according to one embodiment of the invention, a reproduction control apparatus comprises a reception unit configured to receive reproduction collateral information of a content from a first reproduction apparatus connected, via a network, to a recording apparatus for recording a content, the reproduction collateral information being obtained in accordance with reproduction of the content by the first reproduction apparatus, and a transmission unit configured to transmit the reproduction collateral information to a second reproduction apparatus connected to the recording apparatus via the network to instruct reproduction of the content on the basis of the reproduction collateral information.

An embodiment of the present invention will be described below with reference to the accompanying drawing.

Currently, bookmark has been examined as a new function in UPnP (Universal Plug and Play) AV. This function implements pause/resume of a content. UPnP is a standard that mainly defines protocols for device detection between a server device and a client device in an IP network and remote control of the server device.

Upon pausing a content, the above-described bookmark saves reproduction collateral information containing the reproduction stop position, server information, and client information in a server device that saves the content. In resume, reproduction of the content is resumed on the basis of the bookmark.

If the number of users who use the server device that saves the content increases, the number of bookmarks is also expected to increase, as a matter of course. In this case, it is preferable to manage the bookmarks for each user.

However, the current bookmark cannot record user information. Even when the bookmark is extended to handle user information, it is necessary to impart a mechanism to identify a user to the server device and client device.

In this embodiment, upon pausing a content, reproduction collateral information is saved in another control apparatus (reproduction control apparatus) except the server device and client device. In resume, reproduction of the content is resumed from the pause position by transmitting the reproduction collateral information from the control apparatus to the server device (recording apparatus) or client device (reproduction apparatus).

According to this embodiment, a mobile device such as a portable phone for private use is employed as the control apparatus. The user interface need not have a user identification mechanism, unlike a conventional pause/resume system (especially unlike a system that records a bookmark in a server device). This system is useful because the development cost is very low, and user specific management can easily be implemented.

FIG. 1 is a view showing the outline of a reproduction/recording system according to an embodiment of the invention. As shown in FIG. 1, the reproduction/recording system comprises a recording apparatus 11, first reproduction apparatus 12, second reproduction apparatus 13, and control apparatus (reproduction control apparatus) 14. These devices connect to each other via a network. The recording apparatus 11 records a content. That is, the recording apparatus 11 holds a content. In response to a content request from the first reproduction apparatus 12 or second reproduction apparatus 13, the recording apparatus 11 transmits a content to the first reproduction apparatus 12 or second reproduction apparatus 13. The first reproduction apparatus 12 or second reproduction apparatus 13 receives and reproduces the content transmitted from the recording apparatus 11.

In this reproduction/recording system, the recording apparatus 11, first reproduction apparatus 12, and second reproduction apparatus 13 have a function of detecting a device or transmitting/receiving a content via the network, like, e.g., a DLNA supporting device.

The bookmark that is discussed in UPnP Av implements pause/resume of a content. Upon pausing a content, the bookmark saves reproduction collateral information containing the reproduction stop position, server information, and client information in a server device that saves the content. In resume, reproduction of the content is resumed on the basis of the bookmark.

When a server device supporting a bookmark is used in a household, the number of bookmarks probably increases as the number of users increases. In such a case, user specific bookmark management is convenient.

For example, assume an environment where a recording apparatus (server device), reproduction apparatus A (client device), and reproduction apparatus B (client device) connect to each other via a network. The family views, on the reproduction apparatus A, a content recorded in the recording apparatus. Assume that the reproduction apparatus A reproduces the content halfway and pauses it at a reproduction position P, and then, the family views the rest of the content on the reproduction apparatus B in another room. In this case, the information of the reproduction position P is transmitted from the reproduction apparatus A to the recording apparatus as a bookmark. The recording apparatus records the bookmark. The reproduction apparatus B receives the bookmark from the recording apparatus and instructs the recording apparatus to transmit the content from the reproduction position P indicated by the bookmark.

To cause the reproduction apparatus B to execute the pause/resume operation, the reproduction apparatus B must have a user interface to display the list of past bookmarks and make the user designate one of them to reproduce the content.

This pause/resume function is a very beneficial network function for users. However, if this function is used in a family, the number of bookmarks considerably increases, and selection of a desired content is cumbersome. When the number of family members is large, this tendency is more conspicuous. If a specific member of a family alone uses the pause/resume function, bookmarks are meaningless for other members of the family. To solve these problems, bookmarks with personal identification are registered in the recording apparatus. Generally, a method of recording identification information of users (e.g., father, mother, eldest son, eldest daughter, and second son) together with the pause position information P is available. However, the current bookmark cannot record user information. Even when the bookmark is extended to handle user information, it is necessary to impart a mechanism to identify a user to the server device and client device. It is also necessary to select a user on a user interface. To do this, the load in software development becomes heavy.

In this embodiment, a mobile device such as a portable phone for private use is employed as the control apparatus 14. The control apparatus 14 communicates with the recording apparatus 11 or reproduction apparatus 12 to instruct reproduction and pause of a content, acquires reproduction collateral information 15 of the content from the reproduction apparatus 12 in response to the pause instruction, and saves the reproduction collateral information 15. The reproduction collateral information 15 contains, e.g., information indicating the title of the content and the content title storage location (URL or URI) and pause position information. To execute the resume function, the control apparatus 14 transmits the reproduction collateral information 15 to the recording apparatus 11 or reproduction apparatus 13 (or reproduction apparatus 12). The reproduction apparatus 13 requests the paused content (the content from the pause position) of the recording apparatus 11 and resumes reproducing the content from the pause position on the basis of the reproduction collateral information 15 acquired from the control apparatus 14.

As described above, a mobile device such as a portable phone for private use or a PDA for private use is employed as the control apparatus 14. That is, a mobile device for private use saves the reproduction collateral information of a paused content so that only personal information is transmitted/received between the recording apparatus 11 and the reproduction apparatus 13. Hence, bookmark information displayed as, e.g., a list on the reproduction apparatus 13 also contains only personal information (only the reproduction collateral information of a content paused by an individual). It is therefore possible to protect personal information and inhibit display of the reproduction collateral information of a content paused by another person.

That is, since a mobile device for private use is employed as the control apparatus 14, the user interface need not have a user identification mechanism, unlike a conventional pause/resume system (especially unlike a system that records a bookmark in a server device). This system is useful because the development cost is very low, and user specific management can easily be implemented. In addition, the system is excellent in security because personal privacy information is protected.

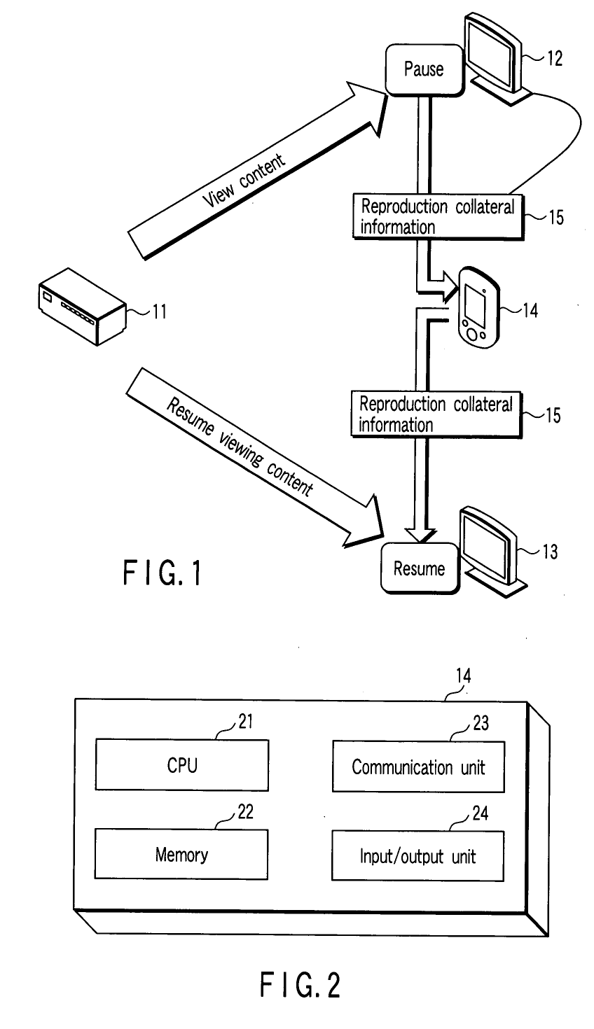

FIG. 2 is a block diagram showing the schematic arrangement of the control apparatus 14. The control apparatus 14 comprises a CPU 21, a memory 22 that records the reproduction collateral information 15, a communication unit 23 that communicates with the remaining apparatuses (recording apparatus 11 and reproduction apparatuses 12 and 13), and an input/output unit 24 to handle a user interface.

The CPU 21 implements various functions by executing programs stored in the memory 22. The CPU 21 controls the units of the apparatus to be described below in cooperation. Upon pause, the control apparatus 14 receives a user instruction from the input/output unit 24, communicates with the recording apparatus 11 or reproduction apparatus 12 via the communication unit 23, collects the reproduction collateral information 15, and stores it in the memory 22. Upon resume, the control apparatus 14 communicates with the recording apparatus 11 or reproduction apparatus 13, transmits the reproduction collateral information 15 stored in the memory 22 to the reproduction apparatus 13, and causes it to resume reproduction on the basis of the reproduction collateral information.

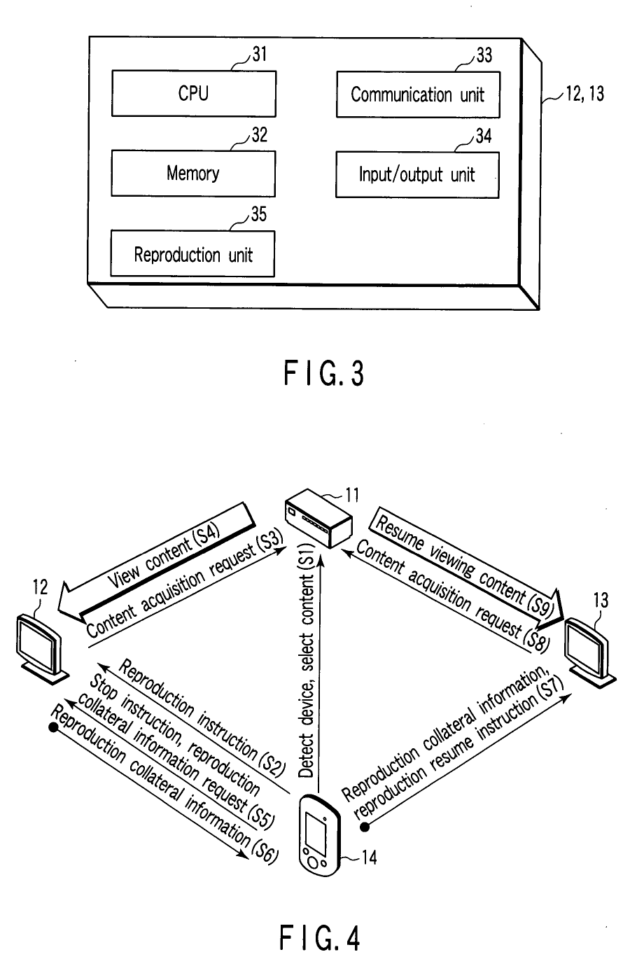

FIG. 3 is a block diagram showing the schematic arrangement of the reproduction apparatuses 12 and 13. Each of the reproduction apparatuses 12 and 13 comprises a CPU 31, a memory 32 that records the reproduction collateral information 15, a communication unit 33 that communicates with the remaining apparatuses, an input/output unit 34 to handle a user interface, and a reproduction unit 35 that reproduces a content.

The CPU 31 implements various functions by executing programs stored in the memory 32. The CPU 31 controls the units of the apparatus to be described below in cooperation. When the communication unit 33 of the reproduction apparatus 12 or 13 receives a content reproduction instruction from the control apparatus 14, the reproduction unit 35 of the reproduction apparatus 12 or 13 acquires the content from the recording apparatus 11 and starts reproducing the content. When the communication unit 33 of the reproduction apparatus 12 or 13 receives a pause instruction from the control apparatus 14, the reproduction unit 35 of the reproduction apparatus 12 or 13 stops reproducing the content. In accordance with the stop of content reproduction, the reproduction collateral information 15 of the content is ensured. The communication unit 33 of the reproduction apparatus 12 or 13 transmits the reproduction collateral information 15 to the control apparatus 14. When the communication unit 33 of the reproduction apparatus 12 or 13 receives a resume instruction and the reproduction collateral information 15 from the control apparatus 14, the reproduction unit 35 of the reproduction apparatus 12 or 13 requests the paused content (the content from the pause position) of the recording apparatus 11 and resumes reproducing the content from the pause position.

FIG. 4 is a view showing an example of reproduction control in the reproduction/recording system. As shown in FIG. 4, the control apparatus 14 detects the device of the recording apparatus 11 (S1) and selects a content stored in the recording apparatus 11 (S1). The control apparatus 14 sends a reproduction instruction to the reproduction apparatus 12 to reproduce the selected content (S2). The reproduction apparatus 12 requests the content of the recording apparatus 11 on the basis of the reproduction instruction (S3). Upon receiving the content request, the recording apparatus 11 transmits the content to the reproduction apparatus 12 (S4). The reproduction apparatus 12 reproduces the content transmitted from the recording apparatus 11.

Then, the control apparatus 14 sends a pause (reproduction stop) instruction to the reproduction apparatus 12 and requests reproduction collateral information (S5). The reproduction apparatus 12 stops reproducing the content and transmits reproduction collateral information obtained in accordance with the reproduction stop of the content (S6). The control apparatus 14 receives and saves the reproduction collateral information.

After that, the control apparatus 14 sends a resume (reproduction resume) instruction to the reproduction apparatus 13 and transmits the reproduction collateral information (S7). The reproduction apparatus 13 receives the reproduction resume instruction and reproduction collateral information and requests the paused content (the content from the pause position) of the recording apparatus 11 on the basis of the reproduction resume instruction and reproduction collateral information (S8). The recording apparatus 11 transmits the paused content (the content from the pause position) to the reproduction apparatus 13. The reproduction apparatus 13 resumes reproduction from the pause position (S9).

As described above, in this embodiment, upon pausing a content, the reproduction collateral information 15 is saved in the control apparatus 14 except the server device and client device. In resume, reproduction is resumed by transmitting the reproduction collateral information 15 from the control apparatus 14 to the server device or client device.

A mobile device such as a portable phone for private use is employed as the control apparatus 14. The user interface need not have a user identification mechanism, unlike a conventional pause/resume system (especially unlike a system that records a bookmark in a server device). Hence, this system is useful because the development cost is very low, and user specific management can easily be implemented. Additionally, it is possible to protect personal privacy even in a family that shares, e.g., a TV.

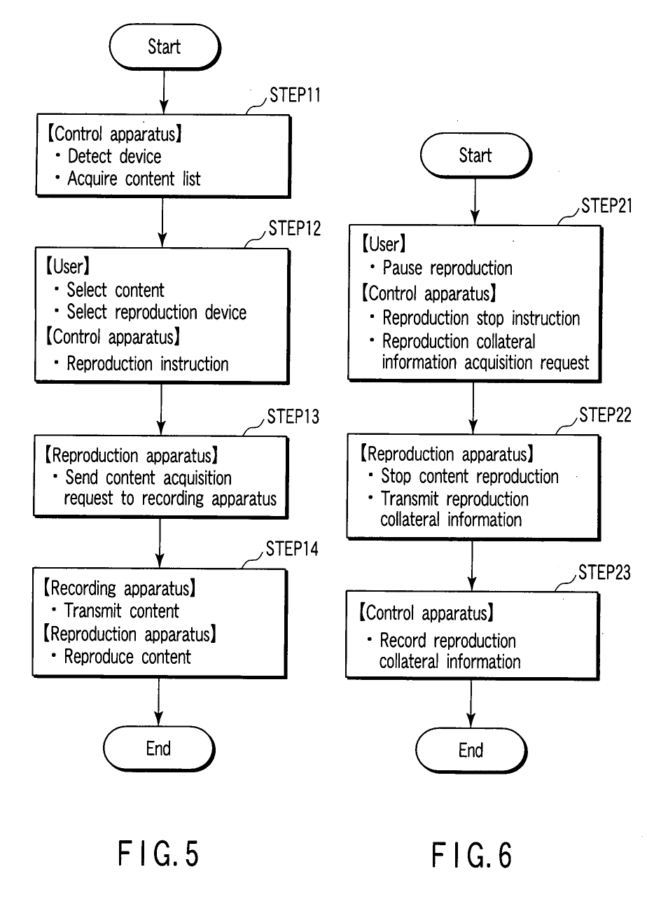

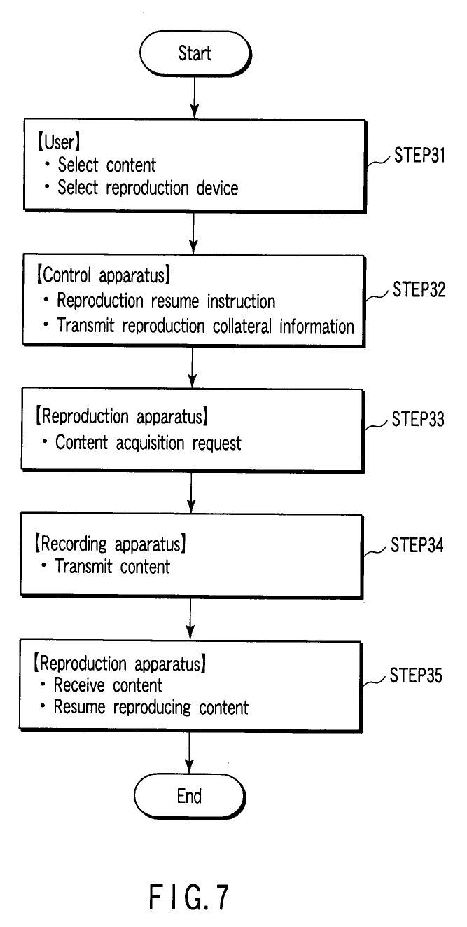

A reproduction start process, reproduction stop process, and reproduction resume process will be described below with reference to the flowcharts in FIGS. 5 to 7. FIG. 5 is a flowchart showing a reproduction start process. FIG. 6 is a flowchart showing a reproduction stop process. FIG. 7 is a flowchart showing a reproduction resume process.

The reproduction start process will be described below with reference to FIG. 5. The control apparatus 14 detects the recording apparatus 11 connected to the network and acquires a list of contents in the recording apparatus 11 (STEP 11). The user selects a reproduction target content from the list by operating the control apparatus 14. The user also selects a reproduction device to reproduce the content. The control apparatus 14 sends a content reproduction instruction to the reproduction apparatus 12 or 13 (STEP 12). The reproduction apparatus 12 or 13 transmits a content acquisition request to the recording apparatus 11 in accordance with the instruction from the control apparatus 14 (STEP 13). Upon receiving the content acquisition request, the recording apparatus 11 sends the designated content to the reproduction apparatus 12 or 13. The reproduction apparatus 12 or 13 reproduces the received content (STEP 14).

The reproduction pause process will be described next with reference to FIG. 6. To pause content reproduction, the control apparatus 14 sends a reproduction pause instruction and a reproduction collateral information acquisition request to the reproduction apparatus 12 or 13 in accordance with a user operation (STEP 21). Upon receiving the instruction, the reproduction apparatus 12 or 13 stops receiving the content from the recording apparatus 11 and stops content reproduction on the reproduction apparatus 12 or 13. The reproduction apparatus 12 or 13 also transmits the reproduction collateral information 15 to the control apparatus 14 in response to the reproduction collateral information acquisition request from it (STEP 22). The control apparatus 14 saves the received reproduction collateral information 15 (STEP 23).

The reproduction resume process will be described next with reference to FIG. 7. To resume reproduction, the user selects a reproduction target content from the list of reproduction collateral information saved in the control apparatus 14 by operating the control apparatus 14. The user also selects the reproduction apparatus 12 or 13 to reproduce the content (STEP 31). The control apparatus 14 sends a reproduction resume instruction and the reproduction collateral information 15 to the reproduction apparatus 12 or 13 selected in STEP 31 (STEP 32). Upon receiving the instruction from the control apparatus 14, the reproduction apparatus 12 or 13 transmits a content acquisition request to the recording apparatus 11. At this time, the reproduction apparatus 12 or 13 requests content acquisition in midstream on the basis of the reproduction collateral information 15 (STEP 33). The recording apparatus 11 transmits the content in midstream on the basis of the reproduction collateral information 15 (STEP 34). The reproduction apparatus 12 or 13 receives the content and resumes reproduction (STEP 35).

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A reproduction control apparatus comprising:
a reception unit configured to receive reproduction collateral information of a content from a first reproduction apparatus connected, via a network, to a recording apparatus for recording a content, the reproduction collateral information being obtained in accordance with reproduction of the content by the first reproduction apparatus; and
a transmission unit configured to transmit the reproduction collateral information to a second reproduction apparatus connected to the recording apparatus via the network to instruct reproduction of the content on the basis of the reproduction collateral information.

2. An apparatus according to claim 1, wherein
the reproduction collateral information contains information indicating a storage location of the content and information indicating a reproduction stop position obtained in accordance with reproduction stop of the content, and
the transmission unit transmits the reproduction collateral information to the second reproduction apparatus to instruct to resume reproduction of the content from the reproduction stop position of the content on the basis of the reproduction collateral information.

3. An apparatus according to claim 1, wherein
the reproduction collateral information contains information specific to the recording apparatus that stores the content, information specific to the content, and information indicating a reproduction stop position obtained in accordance with reproduction stop of the content, and
the transmission unit transmits the reproduction collateral information to the second reproduction apparatus to instruct to resume reproduction of the content from the reproduction stop position of the content on the basis of the reproduction collateral information.

4. An apparatus according to claim 2, wherein the transmission unit instructs the first reproduction apparatus to reproduce the content and stop reproduction of the content.

5. An apparatus according to claim 3, wherein the transmission unit instructs the first reproduction apparatus to reproduce the content and stop reproduction of the content.

6. A reproduction control method comprising:
instructing a first reproduction apparatus connected, via a network, to a recording apparatus for recording a content to reproduce the content;
instructing the first reproduction apparatus to stop reproduction of the content;
receiving, from the first reproduction apparatus, reproduction collateral information of the content obtained in accordance with reproduction and reproduction stop of the content by the first reproduction apparatus; and
transmitting the reproduction collateral information to a second reproduction apparatus connected to the recording apparatus via the network to instruct reproduction of the content on the basis of the reproduction collateral information.

7. A method according to claim 6, wherein
the reproduction collateral information contains information indicating a storage location of the content and information indicating a reproduction stop position obtained in accordance with reproduction stop of the content, and
the reproduction collateral information is transmitted to the second reproduction apparatus to instruct to resume reproduction of the content from the reproduction stop position of the content on the basis of the reproduction collateral information.

8. A method according to claim 6, wherein
the reproduction collateral information contains information specific to the recording apparatus that stores the content, information specific to the content, and information indicating a reproduction stop position obtained in accordance with reproduction stop of the content, and
the reproduction collateral information is transmitted to the second reproduction apparatus to instruct to resume reproduction of the content from the reproduction stop position of the content on the basis of the reproduction collateral information.

9. A reproduction apparatus complying with a UPnP (Universal Plug and Play) standard, comprising:
a reproduction unit configured to reproduce a content acquired from a recording apparatus for recording the content in accordance with a content reproduction instruction; and
a transmission unit configured to transmit reproduction collateral information of the content in response to a request of reproduction collateral information of the content, the reproduction collateral information being obtained in accordance with reproduction of the content.

10. An apparatus according to claim 9, which further comprises a reception unit configured to receive the reproduction collateral information, and
in which the reproduction unit acquires and reproduces the content on the basis of the reproduction collateral information received by the reception unit.

11. An apparatus according to claim 10, wherein
the reproduction collateral information contains information indicating a storage location of the content and information indicating a reproduction stop position obtained in accordance with reproduction stop of the content, and
the reproduction unit acquires the content and resumes reproduction of the content from the reproduction stop position of the content on the basis of the reproduction collateral information received by the reception unit.

12. An apparatus according to claim 10, wherein
the reproduction collateral information contains information specific to the recording apparatus that stores the content, information specific to the content, and information indicating a reproduction stop position obtained in accordance with reproduction stop of the content, and
the reproduction unit acquires the content and resumes reproduction of the content from the reproduction stop position of the content on the basis of the reproduction collateral information received by the reception unit.
